(19) United States
(12) Patent Application Publication
(10) Pub. No.: US 2007/0086047 A1
(43) Pub. Date: Apr. 19, 2007

(54) Image forming system, host device, image forming apparatus and image forming method using the same

(75) Inventor: Hung-joon Oh, Seoul (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/520,006

(22) Filed: Sep. 13, 2006

(30) Foreign Application Priority Data
Oct. 15, 2005 (KR) 2005-97260

(51) Int. Cl. G06F 3/12

(52) U.S. Cl. 358/1.15; 358/1.7

(57) ABSTRACT

An image forming system including an image forming apparatus having a radio frequency identification tag in which printer information is stored, and a host device having a first radio frequency identification reader to read the printer information stored in the radio frequency identification tag and to monitor the image forming apparatus.

### CROSS-REFERENCE TO RELATED APPLICATION

This application claims the benefit of Korean Application No. 2005-97260, filed Oct. 15, 2005, in the Korean Intellectual Property Office, the disclosure of which is incorporated herein by reference.

### BACKGROUND OF THE INVENTION

1. Field of the Invention

An aspect of the present invention relates to an image forming system, and, more particularly, to an image forming system, a host device, an image forming apparatus and an image forming method that effectively identifies and monitors an image forming apparatus.

2. Description of the Related Art

Generally, an image forming system is provided with an image forming apparatus that forms an image on a recording medium (i.e., printing paper, transparency, etc.) and a host device supplying the image information to control the image forming apparatus. The image forming apparatus may be classified into an electrophotographic image forming apparatus that forms an electrostatic latent image by exposing and covering developer on the recording medium using a potential difference, an inkjet image forming apparatus that ejects ink toward the recording medium through micro nozzles, and a thermal transfer image forming apparatus that heats an ink ribbon contacting the recording medium and transfers ink onto the recording medium.

The image forming apparatus is communicatively connected to the host device through a cable or through radio networking. The host device supplies the image information for the image forming apparatus through the cable or radio networking, receives printer information from the image forming apparatus, and performs additional controls of the image forming apparatus.

FIG. 1 is a block diagram illustrating a conventional image forming system. As shown, the image forming system 101 is provided with a host device 110 and an image forming apparatus 120. The host device 110 and the image forming apparatus 120 are communicatively connected to each other through an interface part 130.

The host device 110 is provided with an input part 116, a display part 114 and a host controller 112. The input part 116 receives a command and other information from a user. The display part 114 displays the processed information. The host controller 112 controls the input part 116 and the display part 114.

The image forming apparatus 120 is provided with an image forming part 126, a memory part 124 and a printer controller 122. The image forming part 126 forms an image on the recording medium. The image forming part 126 may be an electrophotographic developing device, an inkjet printer head, a thermal printer head, etc. The memory part 124 stores a proper identification number of the image forming apparatus 120, an IP address, image information to be printed by the image forming part 126, and control information which the printer controller 122 needs to drive the image forming apparatus 120. The printer controller 122 controls the memory part 124 and the image forming part 126.

The host device 110 and the image forming apparatus 120 are communicatively connected to each other through the interface part 130. The interface part 130 may be related to cable or radio networking, and communicates information between the host device 110 and the image forming apparatus 120 by a predetermined protocol. The host device 110 supplies image information for the image forming apparatus 120 through the interface part 130, or controls the image forming apparatus 120 to receive the printer information.

Where the host device 110 is to receive predetermined printer information from the image forming apparatus 120, the host controller 112 commands the printer controller 122 to transmit the predetermined printer information through the interface part 130. The printer controller 112 receives the command of the host controller 112 and reads the printer information from the memory part 124 to transmit the information to the host controller 112 through the interface part 130.

However, in such an image forming system 101, there is a restriction in that, as the host device 110 receives the printer information from the image forming apparatus 120 through the printer controller 122 and the interface part 130, the image forming apparatus 120 must be maintained in a specific state so that the host device 110 receives the printer information from the image forming apparatus 120. For example, where the image forming apparatus 120 is turned off or is busy performing a predetermined operation, the printer controller 122 may not receive the command from the host controller 112 or may not transmit the commanded printer information to the host controller 112. Accordingly, the host device 110 may not always receive desired printer information from the image forming apparatus 120.

Also, where a plurality of image forming apparatuses 120 are connected to the host device 110, when the host device 110 receives the printer information from each image forming apparatus 120, the host device 110 transmits a predetermined command to each image forming apparatus 120, respectively, and collects the predetermined information via the printer controller 122 and the interface part 130 of each of the image forming apparatuses 120. Accordingly, a relatively long time may be required for the host device to identify the plurality of image forming apparatuses 120 and to receive the predetermined printer information.

### SUMMARY OF THE INVENTION

It is therefore an aspect of the present invention to provide an image forming system effectively identifying and monitoring an image forming apparatus.

The foregoing and/or other aspects of the present invention may be achieved by providing an image forming system including an image forming apparatus having a radio frequency identification tag in which printer information is stored, and a host device having a first radio frequency identification reader to read the printer information stored in the radio frequency identification tag and to monitor the image forming apparatus.

According to an aspect of the present invention, the image forming apparatus comprises a memory part to store the printer information and a second radio frequency identification reader to record the printer information in the radio frequency identification tag.

According to an aspect of the present invention, the image forming apparatus comprises a printer controller to detect the change of the information stored in the memory part and then to enable the second radio frequency identification reader to record the changed information in the radio frequency identification tag.

According to an aspect of the present invention, at least one of the host device and the image forming apparatus has a display part, and further comprising a host controller to decode contents which the first radio frequency identification reader reads to display the contents in the display part.

According to an aspect of the present invention, at least one of the host device and the image forming apparatus has a display part, and further comprising a host controller to decode contents which the first radio frequency identification reader reads to display the contents in the display part.

According to an aspect of the present invention, at least one of the host device and the image forming apparatus has a display part, and the host device further comprises a host controller to decode contents which the first radio frequency identification reader reads to display the contents in the display part.

According to an aspect of the present invention, the first radio frequency identification reader transmits a radio wave signal to the radio frequency identification tag to initiate a reception of the printer information.

According to an aspect of the present invention, the first radio frequency identification reader receives a radio wave signal generated by the radio frequency identification tag to initiate a reception of the printer information.

According to an aspect of the present invention, the image forming apparatus comprises component information including hardware information, software information, network information, consumption goods storing information, and a menu map to be chosen by a user, and the printer information relates to at least one of the component information and the menu map.

The foregoing and/or another aspects of the present invention may be achieved by providing a method of operating an image forming apparatus having a radio frequency identification tag in which printer information is stored, and a host device having a first radio frequency identification reader reading the radio frequency identification tag, the method comprising inputting a command to monitor the image forming apparatus, reading the radio frequency identification tag by the first frequency identification reader, and monitoring the image forming apparatus based on the printer information which the first radio frequency identification reader reads.

According to an aspect of the present invention, the image forming apparatus further comprises a memory part to store the printer information, a second radio frequency identification reader to record the printer information in the radio frequency identification tag, the method further comprising, detecting a change in the printer information stored in the memory part before the command inputting operation and/or between the command inputting operation and the reading operation; and recording the changed printer information in the radio frequency identification tag by the second radio frequency identification reader.

According to an aspect of the present invention, at least one of the host device and the image forming apparatus comprises a display part, and the monitoring operation comprises decoding contents which the first frequency identification reader reads and displaying the contents in the display part.

According to an aspect of the present invention, at least one of the host device and the image forming apparatus comprises a display part, and the monitoring operation comprises decoding contents which the first frequency identification reader reads and displaying the contents in the display part.

According to an aspect of the present invention, in the reading stage, the first radio frequency identification transmits a radio wave signal to the radio frequency identification tag to initiate a reception of the printer information.

According to an aspect of the present invention, in the reading stage, the first radio frequency identification reader receives a radio wave signal generated by the radio frequency identification tag to initiate a reception of the printer information.

According to an aspect of the present invention, the image forming apparatus comprises component information including hardware information, software information, network information, consumption goods storing information, and a menu map to be chosen by a user, and the printer information relates to at least one of the component information and the menu map.

The foregoing and/or another aspects of the present invention may be achieved by providing a host device monitoring an image forming apparatus having a radio frequency identification tag in which printer information is stored, the device comprising a first radio frequency identification reader to read the printer information stored in the radio frequency identification tag, and a host controller to monitor the image forming apparatus based on the printer information read by the first radio frequency identification reader.

The foregoing and/or another aspects of the present invention may be achieved by providing an image forming apparatus, comprising a radio frequency identification tag, a memory part to store printer information, a second radio frequency identification reader to record the printer information in the radio frequency identification tag, and a printer controller to detect a change in the printer information stored in the memory part to enable the second radio frequency identification reader to record the changed printer information in the radio frequency identification tag.

Additional and/or other aspects and advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram illustrating a conventional image forming system.

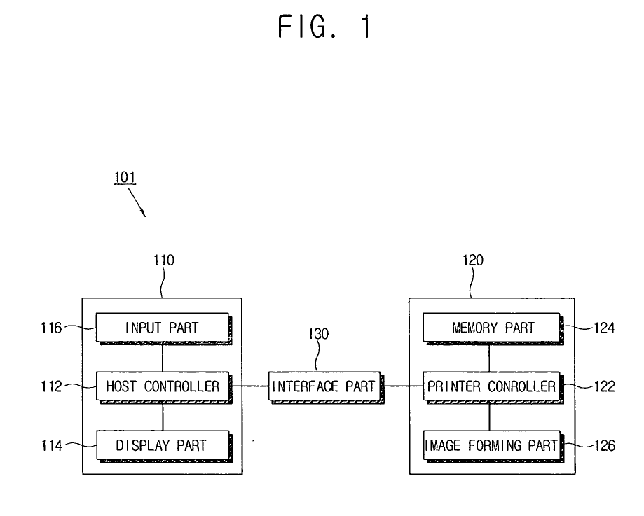

FIG. 2 is a block diagram illustrating an image forming system according to an embodiment of the present invention.

FIG. 3 is a flow diagram illustrating an image forming method according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

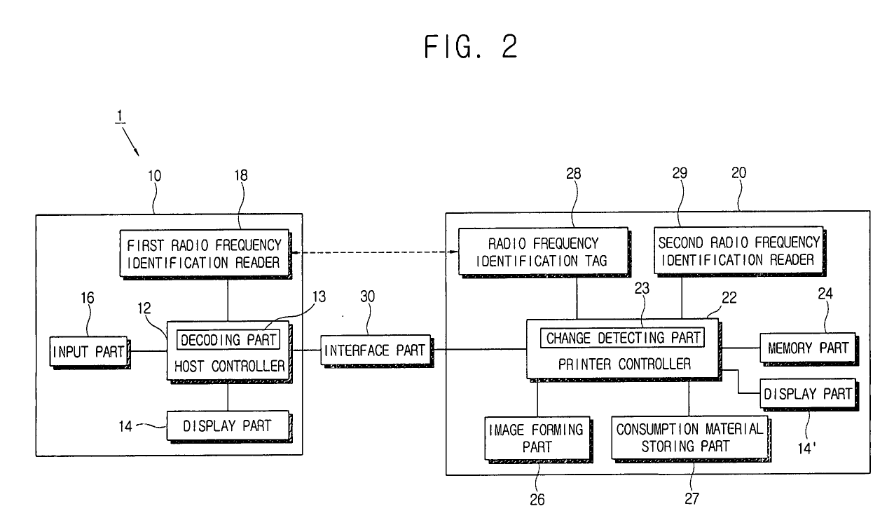

FIG. 2 is a block diagram illustrating an image forming system according to an embodiment of the present invention. As shown, the image forming system 1 is provided with an image forming apparatus 20 having a radio frequency identification (RFID) tag 28 in which printer information is stored, and a host device 10 having a first radio frequency identification reader 18 to read the printer information stored in the radio frequency identification tag 28 and to monitor the image forming apparatus 20.

The image forming apparatus 20 is provided with an image forming part 26 that forms an image on a recording medium (i.e., paper, transparency, etc.). The image forming part 26 may be an electrophotographic developing device, an inkjet printer head, a thermal printer head (THP), and/or a known image forming unit. The image forming apparatus 20 may be a photocopier or a multi-operational device.

The image forming apparatus 20 is provided with a consumption material storing part 27 and a display part 14′. The consumption goods storing part 27 stores consumption goods that are used when the image forming apparatus 26 performs an image forming function (for example, ink, an ink ribbon, printing papers, etc.). The image forming apparatus 20 may also be provided with a storing sensor (not shown) to measure the amount of the goods stored in the consumption goods storing part 27. The display part 14′ displays printer information, or a command and other information received from the host device 10.

The host device 10 may be a known information processing unit capable of processing image information that a personal computer, a lap top computer, and/or another image forming apparatus 20 provides. The host device 10 is provided with an input part 16 and a display part 14. The input part 16 comprises a keyboard, a mouse, and other input devices to be inputted by a user. The display part 14 displays predetermined information a user may identify. The display part 14 may be a monitor or another output device.

The image forming apparatus 20 and the host device 10 are communicatively connected to each other through an interface part 30. A plurality of image forming apparatuses 20 are connected to the host device 10. The host device 10 supplies control information necessary to control the image forming apparatus 20, such as image information for the image forming apparatus 20 through the interface part 30. The interface part 30 comprises a cable or a radio networking device. The interface part 30 may also be omitted as necessary and as permitted by specific situations.

The image forming apparatus 20 is, as described above, provided with the radio frequency identification tag 28 which stores predetermined printer information. The host device 10 is provided with the first radio frequency identification reader 18 to read the radio frequency identification tag 28 in a radio frequency identification method.

The first radio frequency identification reader 18 transmits a predetermined radio carrier wave signal to the radio frequency identification tag 28 to initiate a reception of printer information. When the first radio frequency identification reader 18 transmits the carrier radio wave signal, the radio frequency identification tag 28 reflects the stored printer information with a carrier radio wave frequency that the first radio frequency identification reader 18 transmits. Accordingly, the first radio frequency reader 18 obtains the printer information stored in the radio frequency identification tag 28. Also, the first radio frequency identification reader 18 smoothly reads the radio frequency identification tag 28 by adjusting a radio wave characteristic of the first radio frequency identification reader 18 to be suitable for the distance between the host device 10 and the image forming apparatus 20. As such, the first radio frequency identification reader 18 receives the radio wave signal generated by the radio frequency identification tag 28 to initiate a reception of the printer information. In alternative embodiments of the invention, the first radio frequency identification reader 18 may only read the radio carrier wave signal or may read the radio carrier wave signal and write additional information to be outputted to other devices.

According to a reading method of the first radio frequency identification reader 18, the radio frequency identification tag 28 may be either a passive type to receive and reflect the radio wave signal transmitted by the first frequency identification reader 18 or the radio frequency identification tag 28 may be of an active type to transmit a radio wave signal to the first radio frequency identification reader 18. Also, the radio frequency identification tag 28 may, according to an embodiment of the invention, have an independent power source (not shown) separated from the main power source of the image forming apparatus 20 to generate a radio wave signal regardless of an on/off condition of the image forming apparatus 20. The radio frequency identification tag 28 and the first radio frequency identification reader 18 are disclosed in detail in Korean Patent Application No. 2004-6462 and Korean Patent Application No. 2003-79001, which are each incorporated into the present description.

The image forming apparatus 20 is provided with component information comprising hardware information, software information, network information, consumption goods storing information, and a menu map to be chosen by a user. The printer information stored in the radio frequency identification tag 28 may be information relating to at least one of the component information and the menu map. The hardware information comprises a proper identification number, and memory information of the image forming apparatus 20. The software information comprises operating system information, printer language information, firmware information, etc. The network information comprises an information provider address, and network card information. The consumption goods storing information comprises an amount and a state of the consumption goods sensed by a storing sensor (not shown).

In addition, the printer information may comprise image information which the image forming part 26 receives from the host device 10 to form an image, as well as information about a manager of the image forming apparatus 20 or other related information.

The menu map allows a user to selectively input a command and other information in the image forming apparatus 20. The menu map is displayed in the display part 14′ to be identified by a user. The menu map may comprise a printing menu including the size, the sort, a space, the number of duplicates of a recording medium (i.e., paper, transparency, etc.), an image quality menu related to printing speeds, a toner saving function, a paper feeding menu to allow for a selection of a paper feeding method, a component menu including a power-saving mode, jam correcting directions, a network operation menu, and a test menu.

The image forming apparatus 20 is also provided with a memory part 24, and a second radio frequency identification reader 29 recording the memory information of the memory part 24 on the radio frequency identification tag 28. The memory part 24 may store therein hardware information, software information, network information, consumption goods storing information of the image forming apparatus 20, or image information to be printed by the image forming part 26. The image information may comprise the name, the size, the owner, the manufacturing date of the image forming apparatus 20, and/or login information of the image file. The memory part 24 may be volatile or nonvolatile memory, a hard disk storing the image information received from the host device 10, and/or a combination thereof. The second radio frequency identification reader 29 records a memory of the memory part 24 in the radio frequency identification tag 28 in a predetermined manner. The second radio frequency identification reader 29 comprises an RFID reader having a writing capability. Alternatively, the second radio frequency identification reader 29 may comprise a known recording unit capable of recording in the radio frequency identification tag 28.

Also, the image forming apparatus 20 is provided with a printer controller 22 which detects a change in the memory information of the memory part 24 to enable the second radio frequency identification reader 29 to record the changed information in the radio frequency identification tag 28. The printer controller 22 is provided with a change detecting part 23 to detect the change of the memory information of the memory part 24.

The printer controller 22 enables the second radio frequency identification reader 29 to record the changed information of the memory part 24 in the radio frequency identification tag 28. Accordingly, where the printer information stored in the memory part 24 or the image information changes, such a change may be reflected to the radio frequency identification tag 28. Then, the first radio frequency identification reader 18 may receive the changed printer information.

The host device 10 is also provided with a host controller 12 to decode the contents that the first radio frequency identification reader 18 reads, and to display the contents of at least one of the display part 14 of the host device 10 and the display part 14′ of the image forming apparatus 20. The host controller 12 is provided with a decoding part 13 to decode the printer information which the first radio frequency identification reader 18 reads from the radio frequency identification tag 28. The host controller 12 displays the printer information decoded by the decoding part 13 in the display part 14. Alternatively, the printer controller 22 commands the host controller 12 to display the printer information in the display part 14′ of the image forming apparatus 20 through the interface 30. In addition, the host device 10 may be provided with a memory part (not shown). Here, the host controller 12 may store the printer information decoded by the decoding part 13 in the memory part.

Therefore, in accordance with an aspect of the invention, the host device 10 effectively receives the printer information from the image forming apparatus 20 by a radio frequency identification method to monitor the image forming apparatus 20 even where the image forming apparatus 20 is turned off, where the image forming apparatus 20 is busy performing a predetermined operation, where the interface part 30 does not operate normally, or where the host device 10 cannot communicate information through the interface part 30 for other reasons.

Therefore, in accordance with another aspect of the invention, as the host device 10 receives the printer information by the radio frequency identification method, the host device 10 may always rapidly monitor the state of the image forming apparatus 20. Particularly, where a plurality of image forming apparatuses 20 are connected to the host device 10, the host device 10 may rapidly identify each image forming apparatus 20 by reading the radio frequency identification tag 28 in which a proper identification number is stored for each image forming apparatus 20.

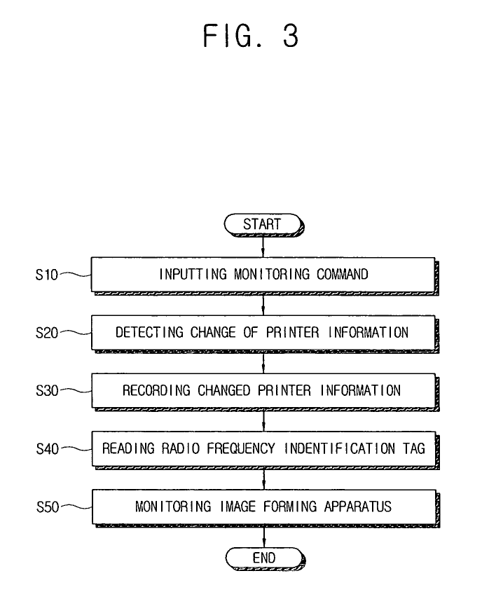

Reference will now be made in detail to the embodiment of the present invention referring to FIGS. 2 and 3. FIG. 3 is a flow diagram illustrating an image forming method according to the embodiment of the present invention. As shown in FIG. 3, in the image forming method a command to monitor the image forming apparatus 20 (10) is inputted. The monitoring command may be inputted by a manager or a user, or by the host controller 12 based on software installed in the host device 10. The monitoring command may be inputted regularly to have a predetermined cycle or may be inputted at random points in time.

When the monitoring command is inputted, the printer controller 22 receives the monitoring to detect the change of the printer information stored in the memory part 24, and enables the second radio frequency identification reader 29 to record the changed printer information in the radio identification frequency tag 28 (30).

Next, the first radio frequency identification reader 18 reads the radio frequency identification tag 28 (40). The first radio frequency identification reader 18 transmits the radio wave signal to the radio frequency identification tag 28 to initiate a reception of the printer information, or receives the radio wave signal generated by the radio frequency identification tag 28 to initiate a reception of the printer information.

Then, the first radio frequency identification reader 18 monitors the image forming apparatus 20 based on the read printer information (50). In operation 50, the host controller 12 decodes the contents which the first radio frequency identification reader 18 reads and displays the contents in one of the display part 14 and 14′. Accordingly, a manager or a user may identify the printer information of the image forming apparatus 20 simply. Also, in the monitoring operation 50, the host controller 12 supplies a necessary command according to the state of the image forming apparatus 20 based on the printer information for the printer controller 20.

In the image forming method shown in the FIG. 3, after the monitoring command inputting operation 10, the detecting of the change of the printer information in operation 20, and the recording of the changed printer information in the radio frequency identification tag 28 in operation 30 are performed. However, in an embodiment of the invention, the change detecting operation 20 and the recording operation 30 may be performed before the command inputting operation 10.

Accordingly, where the printer information recorded on the memory part 24 changes, the printer controller 22 enables the second radio frequency identification reader 29 to record the changed printer information in the radio frequency identification tag 28. Thus, when the monitoring order is inputted (10), the first radio frequency identification reader 18 reads the changed printer information directly from the radio frequency identification tag 28.

As is described above, according to aspects of the present invention, the image forming system using the radio frequency identification identifies and monitors the image forming apparatus at a random point regardless of a power on/off state or a driving state of the image forming apparatus. Particularly, according to aspects of the invention, the image forming system identifies each image forming apparatus simply and rapidly in a plurality of image forming apparatus.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. An image forming system comprising:
an image forming apparatus having a radio frequency identification tag in which printer information is stored; and
a host device having a first radio frequency identification reader to read the printer information stored in the radio frequency identification tag and to monitor the image forming apparatus.

2. The image forming system according to claim 1, wherein the image forming apparatus comprises a memory part to store therein the printer information and a second radio frequency identification reader to record the printer information in the radio frequency identification tag.

3. The image forming system according to claim 2, wherein the image forming apparatus comprises a printer controller to detect the change of the information stored in the memory part and, then, to enable the second radio frequency identification reader to record the changed information in the radio frequency identification tag.

4. The image forming system according to claim 1, wherein at least one of the host device and the image forming apparatus has a display part, and further comprising a host controller to decode contents which the first radio frequency identification reader reads to display the contents in the display part.

5. The image forming system according to claim 2, wherein at least one of the host device and the image forming apparatus has a display part, and further comprising a host controller to decode contents which the first radio frequency identification reader reads to display the contents in the display part.

6. The image forming system according to claim 3, wherein at least one of the host device and the image forming apparatus has a display part, and further comprising a host controller to decode contents which the first radio frequency identification reader reads to display the contents in the display part.

7. The image forming system according to claim 1, wherein the first radio frequency identification reader transmits a radio wave signal to the radio frequency identification tag to initiate a reception of the printer information.

8. The image forming system according to claim 1, wherein the first radio frequency identification reader receives a radio wave signal generated by the radio frequency identification tag to initiate a reception of the printer information.

9. The image forming system according to claim 1, wherein the image forming apparatus comprises component information including hardware information, software information, network information, consumption goods storing information, and/or a menu map to be chosen by a user, and wherein the printer information belongs to at least one of the component information and the menu map.

10. A method of operating an image forming apparatus having a radio frequency identification tag in which printer information is stored, and a host device having a first radio frequency identification reader reading the radio frequency identification tag, the method comprising:
inputting a command to monitor the image forming apparatus;
reading the radio frequency identification tag by the first frequency identification reader; and
monitoring the image forming apparatus based on the printer information which the first radio frequency identification reader reads.

11. The image forming method according to claim 10, wherein the image forming apparatus comprises a memory part to store the printer information, a second radio frequency identification reader to record the printer information in the radio frequency identification tag, and wherein the method further comprises:
detecting a change in the printer information stored in the memory part before the inputting of the command and/or after the inputting of the command and before the reading of the radio frequency identification tag; and
recording the changed printer information in the radio frequency identification tag by the second radio frequency identification reader.

12. The image forming method according to claim 10, wherein at least one of the host device and the image forming apparatus comprises a display part, and the monitoring comprises:
decoding contents that the first frequency identification reader reads; and
displaying the decoded contents in the display part.

13. The image forming method according to claim 11, wherein at least one of the host device and the image forming apparatus comprises a display part, and the monitoring comprises:
decoding contents that the first frequency identification reader reads; and
displaying the decoded contents in the display part.

14. The image forming method according to claim 10, wherein, during the reading, the first radio frequency identification transmits a radio wave signal to the radio frequency identification tag to initiate a reception of the printer information.

15. The image forming method according to claim 10, wherein, during the reading, the first radio frequency identification reader receives a radio wave signal generated by the radio frequency identification tag to receive the printer information.

16. The image forming method according to claim 10, wherein the image forming apparatus comprises component information including hardware information, software information, network information, consumption goods storing information, and/or a menu map to be chosen by a user, and wherein the printer information belongs to at least one of the component information and the menu map.

17. A host device monitoring an image forming apparatus having a radio frequency identification tag in which printer information is stored, the device comprising:
a first radio frequency identification reader to read the printer information stored in the radio frequency identification tag; and
a host controller to monitor the image forming apparatus based on the printer information read by the first radio frequency identification reader.

18. An image forming apparatus, comprising:
a radio frequency identification tag;
a memory part to store printer information;
a second radio frequency identification reader to record the printer information in the radio frequency identification tag; and
a printer controller to detect a change in the printer information stored in the memory part to enable the second radio frequency identification reader to record the changed printer information in the radio frequency identification tag.

19. An image forming method for use with at least one host device connected to an image forming apparatus, comprising:
inputting a monitoring command to monitor the image forming apparatus;
detecting changed printer information as compared with printer information stored in the image forming apparatus and recording the changed printer information in a radio frequency (RF) identification (ID) tag;
reading the printer information in the RFID tag in the host device; and
monitoring the image forming apparatus in the host device based on the read printer information.

20. The method according to claim 19, wherein the monitoring command is inputted regularly or is inputted at random points in time.

21. The method according to claim 19, wherein the reading of the RFID tag comprises transmitting a radio wave signal to the radio frequency identification tag to initiate a reception of the printer information

22. The method according to claim 19, wherein the reading of the RFID tag comprises receiving a radio wave signal generated by the radio frequency identification tag to initiate a reception of the printer information.

23. The method according to claim 19, wherein, during the monitoring, the method further comprises:
decoding the read printer information; and
displaying the decoded printer information.

24. An image forming method for use with at least one host device connected to an image forming apparatus, comprising:
detecting changed printer information as compared with printer information stored in the image forming apparatus and recording the changed printer information in a radio frequency (RF) identification (ID) tag;
inputting a monitoring command to monitor the image forming apparatus;
reading the printer information in the RFID tag in the host device; and
monitoring the image forming apparatus in the host device based on the read printer information.

25. An image forming system, in which at least one host device is connected to an image forming apparatus, where printer information recorded in a memory of the image forming apparatus changes, a controller of the image forming apparatus enables a recording of the changed printer information in a radio frequency identification tag of the image forming apparatus, such that, when a monitoring order is inputted to the host device, a first radio frequency identification reader of the host device reads the changed printer information directly from the radio frequency identification tag.

26. A host device to receive printer information from an image forming apparatus to monitor the image forming apparatus even where the image forming apparatus is turned off, where the image forming apparatus is busy performing a predetermined operation, where an interface part to connect the host device to the image forming apparatus does not operate normally, or where the host device cannot communicate information through the interface part to the image forming apparatus.
